(19) United States
(12) Patent Application Publication
(10) Pub. No.: US 2026/0157927 A1
(43) Pub. Date: Jun. 11, 2026

(54) METHOD FOR IMPROVING ATTENTION FUNCTION OF A SUBJECT, METHOD FOR IMPROVING FLUENCY OF A SUBJECT, AND METHOD FOR IMPROVING CONGNITIVE FUNCTION OF A SUBJECT

(71) Applicants: Pixie Dust Technologies, Inc., Tokyo (JP); Shionogi & Co., Ltd., Osaka (JP)

(72) Inventors: Yoshiki NAGATANI, Chuo-ku (JP); Kazuki TAKAZAWA, Chuo-ku (JP); Taiki KASAI, Chuo-ku (JP); Aya KAMBARA, Chuo-ku (JP); Hana KIKUCHI, Chuo-ku (JP); Makiko ABE, Chuo-ku (JP); Wei CHEN, Chuo-ku (JP)

(73) Assignees: Pixie Dust Technologies, Inc., Tokyo (JP); Shionogi & Co., Ltd., Osaka (JP)

(21) Appl. No.: 19/413,132

(22) Filed: Dec. 9, 2025

(30) Foreign Application Priority Data
Dec. 10, 2024 (JP) 2024-215471
Jan. 21, 2025 (JP) 2025-008166

(51) Int. Cl. A61H 23/02; G10K 15/02

(52) U.S. Cl. CPC A61H 23/0236; G10K 15/02; A61H 2201/5005; A61H 2201/5048

(57) ABSTRACT

A method for improving attention function of a subject includes generating an acoustic signal having periodic fluctuations corresponding to the frequency of gamma waves; and improving the attention function of the subject by administering an auditory stimulus based on the acoustic signal to the subject.

### CROSS-REFERENCE TO RELATED APPLICATIONS

This application claims priority from Japanese Patent Application No. 2024-215471, filed on Dec. 10, 2024, and Japanese Patent Application No. 2025-008166, filed on Jan. 21, 2025. The entire teachings of the above applications are incorporated herein by reference.

### TECHNICAL FIELD

The present invention relates to a computer, a method for improving attention function of a subject, a method for improving fluency of a subject, and a method for improving cognitive function of a subject, the method comprising.

### BACKGROUND

There is a research report that when pulse-like auditory stimulus at a frequency of about 40 times per second are perceived by Alzheimer's disease model mice, inducing gamma waves in their brains, it was effective in improving spatial memory and recognition memory. (See Multi-sensory Gamma Stimulation Ameliorates Alzheimer's-Associated Pathology and Improves Cognition Cell 2019 April 4;177(2):256-271.e22. doi: 10.1016/j.cell.2019.02.014.). Gamma waves refer to neural oscillations captured by electrophysiological methods such as electroencephalography (EEG) or magnetoencephalography (MEG), representing periodic neural activity in the cerebral cortex with frequencies within the gamma band (25 to 140 Hz).

### SUMMARY

However, the effects obtained when auditory stimuli of specific frequencies are administered to humans have not been verified.

The purpose of this disclosure is to provide a technology that positively influences human brain function through auditory stimulus of specific frequencies.

A method for improving attention function of a subject, the method comprising: generating an acoustic signal having periodic fluctuations corresponding to a frequency of gamma waves; and improving the attention function of the subject by administering an auditory stimulus based on the generated acoustic signal to the subject.

### BRIEF DESCRIPTION OF THE DRAWINGS

FIG. 1 is a block diagram showing the configuration of the acoustic system of the present embodiment.

FIG. 2 is a block diagram showing the configuration of the signal processing device of the present embodiment.

FIG. 3 is an explanatory diagram of one embodiment of the present invention.

FIG. 4 is an explanatory diagram of one embodiment of the present invention.

FIG. 5 is a diagram showing the amplitude waveform of the first example of the output acoustic signal.

FIG. 6 is a diagram showing the amplitude waveform of the second example of the output acoustic signal.

FIG. 7 is a diagram showing the amplitude waveform of the third example of the output acoustic signal.

FIG. 8 is a diagram showing the waveform of the fourth example of the output acoustic signal.

FIG. 9 is a diagram showing the waveform of the fifth example of the output acoustic signal.

FIG. 10 is a diagram showing the waveform of the stimulus sound used in the experiment of Example 1.

FIG. 11 is a diagram showing the results of the experiment of Example 1.

FIG. 12 is a diagram showing the results of the category fluency task in Example 2.

FIG. 13 is a diagram showing the results of the idea fluency task in Example 2.

FIG. 14 is a diagram showing the results of the sustained attention task in Example 3.

FIG. 15 is a diagram showing the results of the sustained attention task in Example 3.

FIG. 16 is a diagram showing the overall flow of acoustic signal processing by the signal processing device of this embodiment.

### DETAILED DESCRIPTION

Hereinafter, one embodiment of the present invention will be described in detail with reference to the drawings. In the drawings for explaining the embodiments, the same reference numerals are basically given to the same components, and repetitive explanation thereof is omitted.

### (1) Configuration of the Acoustic System

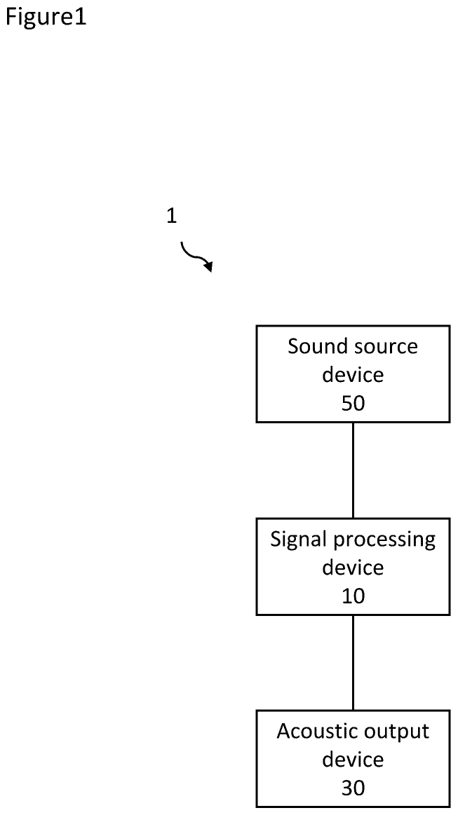

Description of the configuration of the acoustic system. FIG. 1 is a block diagram showing the configuration of the acoustic system according to this embodiment.

As shown in FIG. 1, the acoustic system 1 includes a signal processing device 10, an acoustic output device 30, and a sound source device 50.

The signal processing device 10 and the sound source device 50 are connected to each other via a predetermined interface capable of transmitting acoustic signals. The interface is, for example, an SPDIF (Sony Philips Digital Interface), HDMI (registered trademark) (High-Definition Multimedia Interface), a pin connector (RCA pin), or an audio interface for headphones. The interface may also be a wireless interface using, for example, Bluetooth (registered trademark). The signal processing device 10 and the acoustic output device 30 are similarly connected to each other via a predetermined interface. The acoustic signal in this embodiment includes either or both of an analog signal and a digital signal.

The signal processing device 10 performs acoustic signal processing on the input acoustic signal obtained from the sound source device 50. The acoustic signal processing by the signal processing device 10 includes, for example, modulation processing of the acoustic signal, or processing that adds an auxiliary acoustic signal with periodic variations to the input acoustic signal. In addition, the acoustic signal processing by the signal processing device 10 may include conversion processing of the acoustic signal (such as separation, extraction, or synthesis). Furthermore, the acoustic signal processing by the signal processing device 10 may also include amplification processing of the acoustic signal similar to that of an AV amplifier, for example. In addition, the signal processing device 10 may perform acoustic signal processing that independently generates an acoustic signal with periodic variations without acquiring an input acoustic signal from the sound source device 50. The signal processing device 10 transmits the output acoustic signal generated by the acoustic signal processing to the acoustic output device 30. The signal processing device 10 is an example of an information processing device.

The acoustic output device 30 administers an auditory stimulus to the listener by generating sound corresponding to the output acoustic signal obtained from the signal processing device 10. The acoustic output device 30 is, for example, a loudspeaker (which may include an amplifier built-in speaker (powered speaker)), headphones, or earphones. The acoustic output device 30 can be configured as a single device together with the signal processing device 10. Specifically, the signal processing device 10 and the acoustic output device 30 can be implemented in a TV, radio, music player, AV amplifier, speaker, headphones, earphones, smartphone, or PC. The subject (listener) administered with the auditory stimulus by the acoustic output device 30 can expect at least one of the following improvements, as described later: improved attention function, improved fluency, improved executive function, improved creativity, and improved cognitive function. That is, the signal processing device 10 and the acoustic output device 30 constitute the attention function improvement system, fluency improvement system, executive function improvement system, creativity improvement system, and cognitive function improvement system.

The sound source device 50 sends the input acoustic signal to the signal processing device 10. The sound source device 50 is, for example, a TV, radio, music player, smartphone, PC, electronic musical instrument, telephone, game machine, amusement machine, or a device that transmits an acoustic signal via broadcasting or information communication.

### (1-1) Configuration of the Signal Processing Device

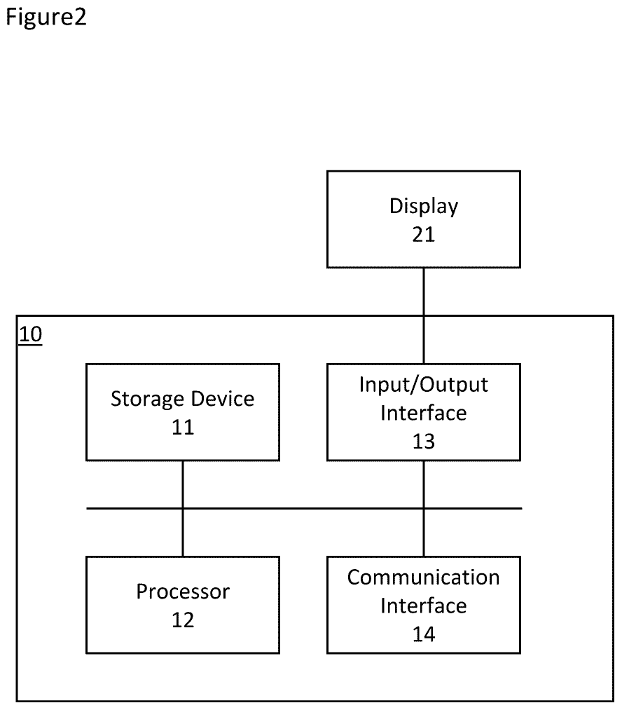

The configuration of the signal processing device will be described. FIG. 2 is a block diagram illustrating the configuration of a signal processing device according to the present embodiment

As shown in FIG. 2, the signal processing device 10 includes a storage device 11, a processor 12, an input/output interface 13, and a communication interface 14. The signal processing device 10 is connected to a display 21.

The storage device 11 is configured to store programs and data. The storage device 11 is, for example, a combination of ROM (Read Only Memory), RAM (Random Access Memory), and storage (for example, flash memory or hard disk). Programs and data may be provided via a network or recorded on a computer-readable recording medium and provided.

The program includes, for example, the following programs.
Operating System (OS) program
Application programs that perform information processing

The data includes, for example, the following data.
The database referenced during information processing
Data obtained by executing information processing (i.e., the result of information processing execution)

The processor 12 is a computer that realizes the functions of the signal processing device 10 by reading and executing the program stored in the storage device 11. Note that at least part of the functions of the signal processing device 10 may be realized by one or more dedicated circuits. The processor 12 is, for example, at least one of the following.
CPU (Central Processing Unit)
GPU (Graphic Processing Unit)
ASIC (Application Specific Integrated Circuit)
FPGA (Field Programmable Array)
DSP (Digital Signal Processor)

The input/output interface 13 is configured to receive instructions from an input device connected to the signal processing device 10 and to output information to an output device connected to the signal processing device 10. The input devices include, for example, a sound source device 50, physical buttons, a keyboard, pointing devices, touch panels, or combinations thereof. The output devices include, for example, the display 21, the acoustic output device 30, or a combination of these.

Furthermore, the input/output interface 13 may include hardware for signal processing such as an A/D converter, D/A converter, amplifier, mixer, filter, and the like.

The communication interface 14 is configured to control communication between the signal processing device 10 and external devices (for example, the acoustic output device 30 or the sound source device 50).

Display 21 is configured to display images (still images or videos). Display 21 is, for example, a liquid crystal display or an organic EL display.

### (2) One Embodiment of the Implementation

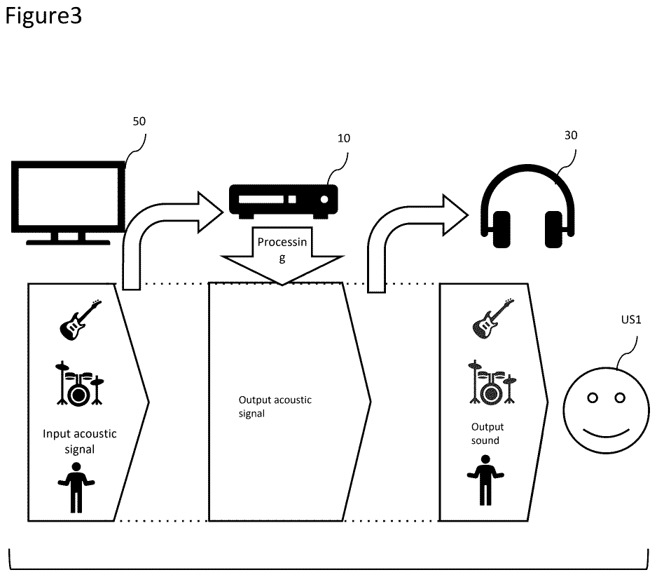

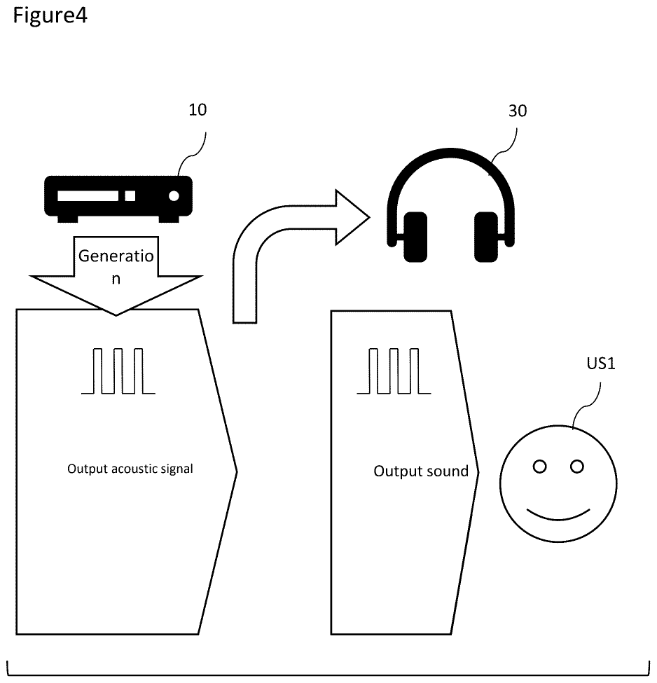

An explanation will be given for one embodiment of this implementation. FIG. 3 and FIG. 4 are explanatory diagrams of one embodiment of this implementation.

### (2-1) Overview of the Embodiment

FIG. 3 shows an example of a case where the signal processing device 10 generates an output acoustic signal by performing acoustic signal processing that modifies the input acoustic signal obtained from the sound source device 50. As shown in FIG. 3, the signal processing device 10 acquires an input acoustic signal from the sound source device 50. The signal processing device 10 generates an output acoustic signal by performing acoustic signal processing on the input acoustic signal.

The first example of acoustic signal processing is a process that modulates the input acoustic signal. The modulation is amplitude modulation using a modulation function with a frequency corresponding to gamma waves (for example, a frequency between 35 Hz and 45 Hz). As a result, the acoustic signal is given changes in amplitude corresponding to the above frequency (periodic fluctuations in volume intensity). When different modulation functions are applied to the same input acoustic signal, the amplitude waveform of the output acoustic signal differs. Examples of amplitude waveforms will be described later.

The second example of acoustic signal processing is a technique where an auxiliary acoustic signal with periodic fluctuations corresponding to the frequency of gamma waves is added to the input acoustic signal. As a result, the acoustic signal after addition also exhibits periodic fluctuations corresponding to the frequency of gamma waves. The auxiliary acoustic signal, for example, may be a signal with pulses corresponding to the period of the gamma wave frequency, but it is not limited to this. For example, the auxiliary acoustic signal may be a sine wave corresponding to the frequency of the gamma wave, or it may be generated by applying amplitude modulation according to the frequency of the gamma wave to any acoustic signal such as noise or music.

Signal processing device 10 sends the output acoustic signal to the acoustic output device 30. The acoustic output device 30 generates an output sound corresponding to the output acoustic signal and administers an auditory stimulus based on the output acoustic signal to the subject (user US1).

User US1 (an example of “listener”) receives the auditory stimulus administered by the acoustic output device 30. User US1 is, for example, a dementia patient, a pre-dementia group member, or a healthy person who seeks improvement in brain function. As mentioned above, the output acoustic signal is based on an output acoustic signal having a periodic fluctuation between 35 Hz and 45 Hz. Therefore, by listening to the sound emitted from the acoustic output device 30, user US1 can experience a positive effect on their brain function.

FIG. 4 shows an example of a case where the signal processing device 10 generates an output acoustic signal by performing acoustic signal processing that independently generates an acoustic signal with periodic variations, without acquiring an input acoustic signal from the sound source device 50. The acoustic signal generated by acoustic signal processing is, for example, a signal with pulses corresponding to the frequency of gamma waves (for instance, a frequency between 35 Hz and 45 Hz), but is not limited to this. For example, the auxiliary acoustic signal may be a sine wave corresponding to the gamma wave frequency.

The signal processing device 10 sends the output acoustic signal to the acoustic output device 30. The acoustic output device 30 generates output sound corresponding to the output acoustic signal and administers an auditory stimulus based on the output acoustic signal to the subject (user US1). User US1 receives the auditory stimulus administered by the acoustic output device 30. The output acoustic signal has a periodic variation between 35 Hz and 45 Hz. Therefore, by listening to the sound emitted from the acoustic output device 30, user US1 can have a beneficial effect on their brain function.

### (2-2) First Example of the Output Acoustic Signal

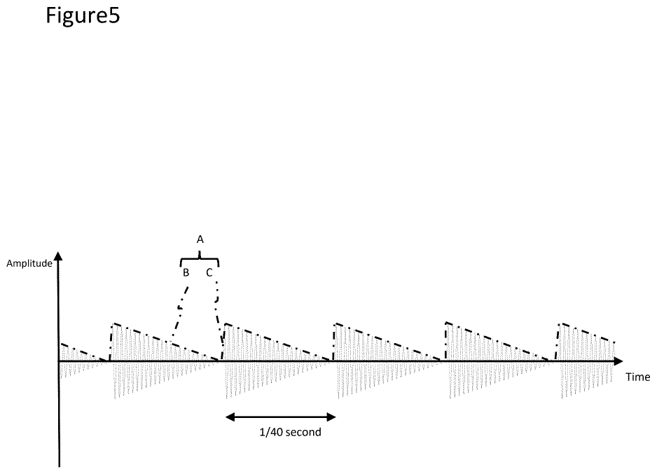

FIG. 5 is a diagram showing the amplitude waveform of the first example of the output acoustic signal generated by amplitude modulation according to the frequency of gamma waves applied to the input acoustic signal. Let the modulation function used for modulating the input acoustic signal be A(t), the function representing the waveform of the input acoustic signal before modulation be X(t), and the function representing the waveform of the output acoustic signal after modulation be Y(t).

Y(t)=A(t)·X(t)

holds.

In the first example, the modulation function has an inverse sawtooth waveform at 40 Hz. The input acoustic signal has a constant frequency higher than 40 Hz and a constant sound pressure, representing a uniform sound. As a result, the envelope of the amplitude waveform of the output acoustic signal takes the shape that follows the inverse sawtooth wave.

Specifically, as shown in FIG. 5, the amplitude waveform of the output acoustic signal has amplitude variations corresponding to the frequency of gamma waves, and the rising portion C and falling portion B of the envelope A of the amplitude waveform are asymmetric (in other words, the duration of the rising time and the falling time are different).

In the first example, the rise of the envelope A of the amplitude waveform of the output acoustic signal is steeper compared to the fall. In other words, the rise time is shorter than the fall time. The amplitude value of the envelope A rises sharply to its maximum amplitude and then gradually decreases over time. That is, envelope A takes the form of an inverted sawtooth wave.

### (2-3) Second Example of Output Acoustic Signal

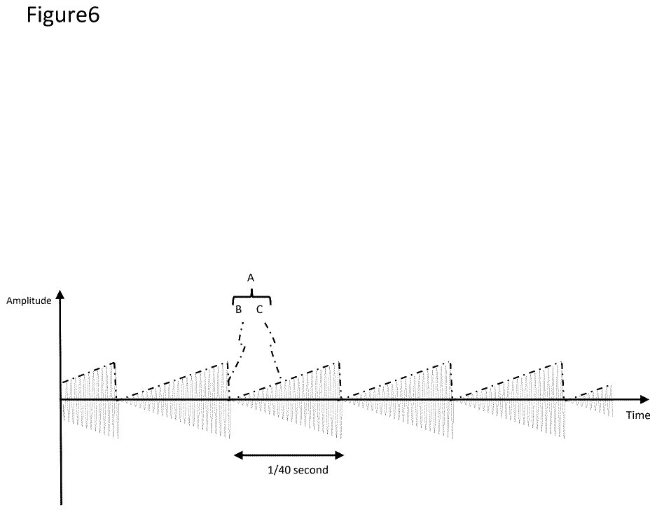

The second example of the output acoustic signal will be explained. FIG. 6 is a diagram showing the amplitude waveform of the output acoustic signal according to a second example, which is generated by performing amplitude modulation corresponding to the frequency of the gamma wave on the input acoustic signal.

In the second example, the modulation function has a sawtooth waveform of 40 Hz. The input acoustic signal has a constant frequency higher than 40 Hz and a constant sound pressure, representing a uniform sound. As a result, the envelope of the amplitude waveform of the output acoustic signal takes the shape of the sawtooth waveform.

Specifically, as shown in FIG. 6, the falling edge of the envelope A of the amplitude waveform of the output acoustic signal in the second example is steeper compared to the rising edge. In other words, the fall time is shorter than the rising time. The amplitude value of the envelope A gradually rises over time to the maximum amplitude and then sharply decreases. That is, the envelope A has a sawtooth waveform shape.

### (2-4) Third Example of the Output Acoustic Signal

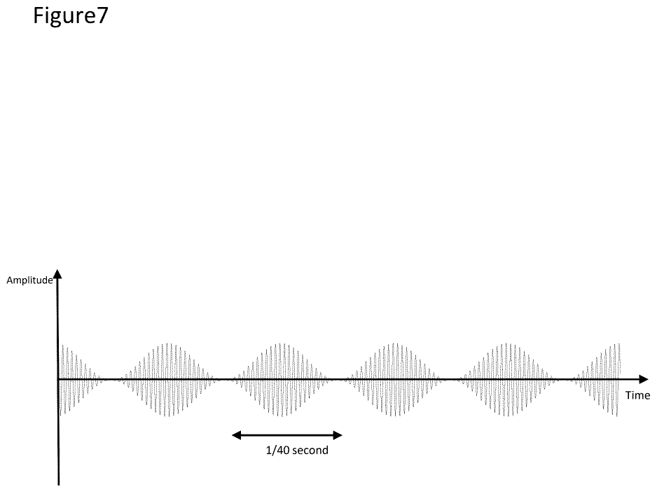

The third example of the output acoustic signal is explained. FIG. 7 is a diagram showing the amplitude waveform of the third example of the output acoustic signal generated by amplitude modulation according to the frequency of gamma waves on the input acoustic signal.

In the third example, the modulation function has a sinusoidal waveform of 40 Hz. The input acoustic signal has a constant frequency higher than 40 Hz and a constant sound pressure, representing a uniform sound. As a result, the envelope of the amplitude waveform of the output acoustic signal takes on a shape that follows a sine wave.

Specifically, as shown in FIG. 7, the rise and fall of envelope A of the amplitude waveform of the output acoustic signal in the third example are both smooth. That is, envelope A is shaped like a sine wave.

In the above Examples 1 through 3, the modulation function was assumed to have a periodicity of 40 Hz, but the frequency of the modulation function is not limited to this and may be, for example, a frequency between 35 Hz and 45 Hz. Also, in Examples 1 through 3 above, the absolute value of the amplitude of the envelope A was assumed to periodically reach zero, but this is not limited, and a modulation function that results in the minimum absolute amplitude value of envelope A being greater than zero (for example, one-half or one-quarter of the maximum absolute value) may be used.

In the examples shown in FIG. 5 to FIG. 7, the sound pressure and frequency of the input acoustic signal were assumed to be constant, but the sound pressure and frequency of the input acoustic signal may change. For example, the input acoustic signal may represent music, voice, environmental sounds, electronic sounds, or noise. In this case, the envelope of the output acoustic signal's amplitude waveform, strictly speaking, takes a shape different from a waveform representing the modulation function, but the rough shape of the envelope resembles the waveform representing the modulation function (for example, a reversed sawtooth wave, a sawtooth wave, or a sine wave), allowing the listener to experience auditory stimuli similar to those when the input acoustic signal's sound pressure and frequency are constant.

### (2-4) Fourth Example of Output Acoustic Signal

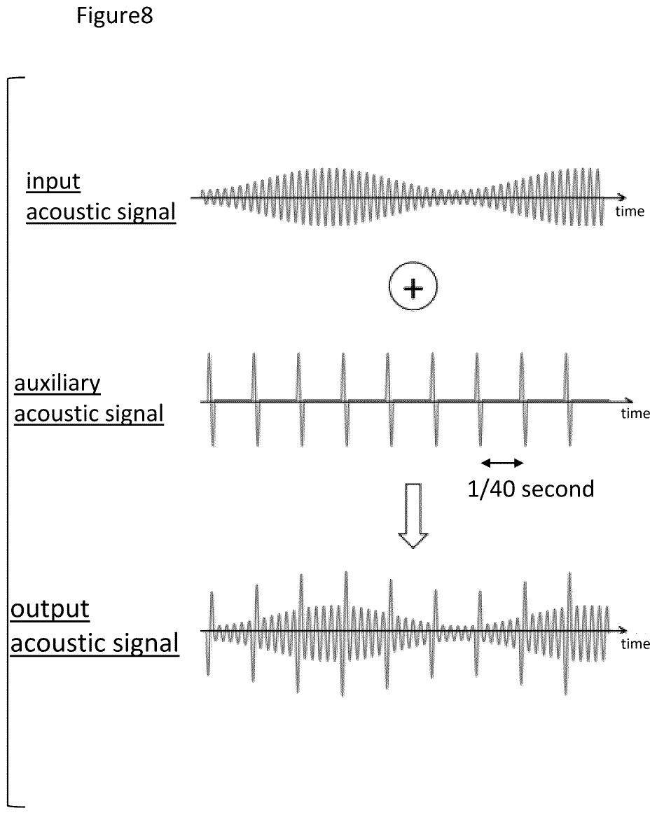

The fourth example of the output acoustic signal is explained. FIG. 8 is a diagram showing the waveform of a fourth example of an output acoustic signal generated by adding an auxiliary acoustic signal to an input acoustic signal.

In the fourth example, the auxiliary acoustic signal includes pulses with a period of 1/40 seconds. The input acoustic signal has a constant frequency higher than 40 Hz and is an acoustic signal whose sound pressure changes gradually. As a result, as shown in FIG. 8, the output acoustic signal has pulses with a period of 1/40 seconds, and the parts other than the pulses have a waveform similar to that of the input acoustic signal.

### (2-5) Fifth Example of Output Acoustic Signal

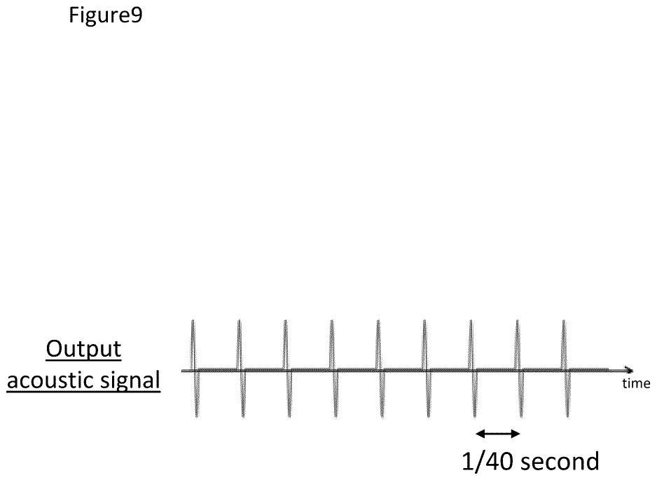

The fifth example of the output acoustic signal is explained. FIG. 9 is a diagram showing the waveform of the fifth example of the output acoustic signal, which is generated independently without using an input acoustic signal. In the fifth example, the output acoustic signal is a signal having pulses with a period of 1/40 seconds.

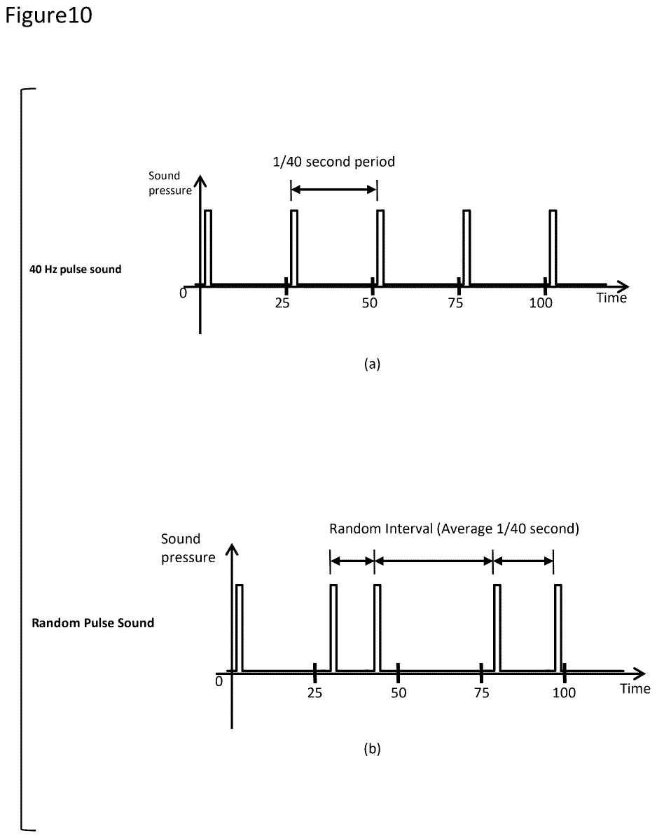

In the above fourth and fifth examples, the pulse is assumed to have a period of 1/40 seconds (corresponding to a frequency of 40 Hz), but the pulse period is not limited to this and may, for example, correspond to a frequency between 35 Hz and 45 Hz. Also, in the auxiliary acoustic signal in the above fourth example and the output acoustic signal in the fifth example, the pulse width and sound pressure are assumed to be constant, but this is not exclusive, and at least one of the pulse width or sound pressure may vary. A 40 Hz periodic pulse sound (a sound containing a 1 ms rectangular wave every 25 ms) was prepared as the intervention sound, and a random pulse sound (a sound containing a 1 ms rectangular wave at random intervals (a uniform distribution averaging every 25 ms)) was prepared as the SHAM sound. These stimulus sounds were administered through headphones for 45 minutes. The volume of the stimulus sounds was set to an equivalent noise level of 60 dB plus hearing level for 27 subjects, and to 60 dB for 11 subjects. FIG. 10 shows the waveforms of the stimulus sounds used in the experiment of Example 1. FIG. 10(a) shows the waveform of the 40 Hz pulse sound with periodic variation used as the intervention sound, and FIG. 10(b) shows the waveform of the random pulse sound used as the SHAM sound.

### (3) EXAMPLES

### (3-1) Example 1

An example of implementing the technology of this disclosure is described. In the experiment according to Example 1, 38 participants were randomly assigned to the intervention group (19 people, 63.2±5.0 years old) and the SHAM group (19 people, 63.3±4.8 years old). A 40 Hz periodic pulse sound (a sound containing a 1 ms rectangular wave every 25 ms) was prepared as the intervention sound, and a random pulse sound (a sound containing a 1 ms rectangular wave at random intervals (a uniform distribution averaging every 25 ms)) was prepared as the SHAM sound. These stimulus sounds were administered through headphones for 45 minutes. The volume of the stimulus sounds was set to an equivalent noise level of 60 dB plus hearing level for 27 subjects, and to 60 dB for 11 subjects. FIG. 10 shows the waveforms of the stimulus sounds used in the experiment of Example 1. FIG. 10 (a) shows the waveform of the 40 Hz pulse sound with periodic variation used as the intervention sound, and FIG. 10 (b) shows the waveform of the random pulse sound used as the SHAM sound.

The Category Fluency Task (CFT) was administered before and after the presentation of the above audio recordings. The CFT is a task that requires the efficient use of semantic memory, involving the retrieval of words belonging to a given semantic category from their stored vocabulary. The CFT allows for the evaluation of cognitive functions related to language, memory, and executive functions of the subjects, particularly those cognitive functions influenced by the activation of the frontal lobe, hippocampus, and precuneus. CFT is a type of Word Fluency Task (WFT), and WFT is one of the tasks administered in the Frontal Assessment Battery(FAB).

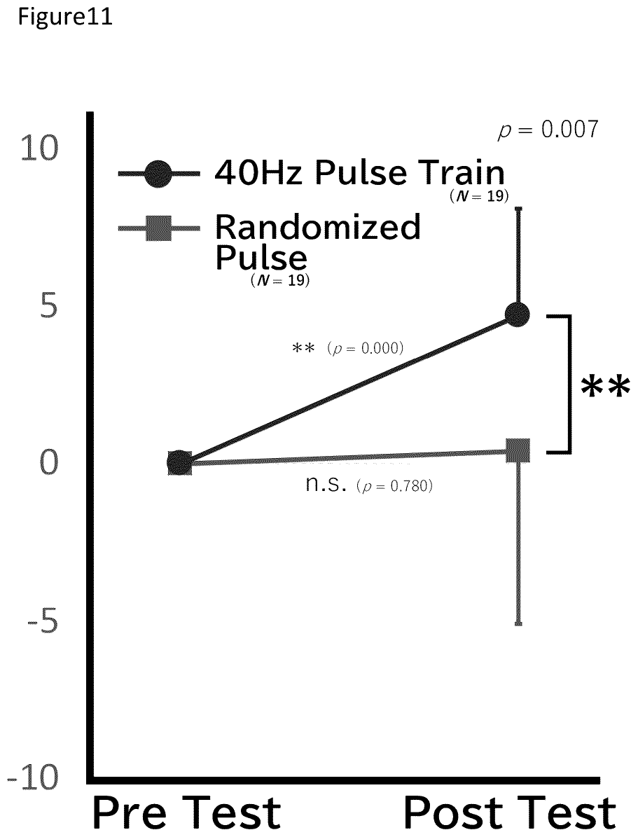

The specific details of the CFT conducted in Experiment 1 are as follows. In the measurement before the sound source presentation, the subjects were asked to name as many words as possible belonging to the category “vegetables” within 60 seconds, and the number of words they were able to name was counted. In the measurement after the sound source presentation, the subjects were asked to name as many words as possible within 60 seconds that belonged to the category “animals,” and the number of words named was counted. Then, based on the number of words counted before and after the sound source presentation, a score was evaluated. The results are shown in FIG. 11. FIG. 11 shows the results of the experiment in Example 1.

As shown in FIG. 11, the score significantly improved only in the intervention group that listened to the 40 Hz periodic pulse sound. Specifically, the change in score before and after the sound presentation was +4.7±3.4 points (p=0.000) in the intervention group, and +0.4±5.5 points (p=0.780) in the SHAM group, with the difference between groups being p=0.007.

### (3-2) Example 2

In the experiment according to Example 2, 39 subjects were randomly assigned to the intervention group (19 people, 62.5±5.5 years old) and the SHAM group (20 people, 63.3±6.1 years old). As the intervention sound, a modulated tone generated by amplitude-modulating the audio signal of the music content at 40 Hz was prepared, and as the SHAM sound, a modulated tone generated by amplitude-modulating the audio signal of the music content at 80 Hz was prepared. These stimulus sounds were administered through a speaker for 60 minutes. The volume of the stimulus sound was set with 54 dBA as the baseline, corrected according to the three-tone hearing level (up to a maximum of 74 dBA).

Before and after the presentation of the above sound sources, measurements were taken for the category fluency task (CFT) and the idea fluency task (IFT). As an IFT, we used one that belongs to the Use Test contained in the TCT (Test for Creative Thinking). By using IFT, it is possible to evaluate cognitive functions related to the subject's language, memory, and executive functions (particularly cognitive functions affected by at least one of the activation of the frontal lobe, hippocampus, and precuneus).

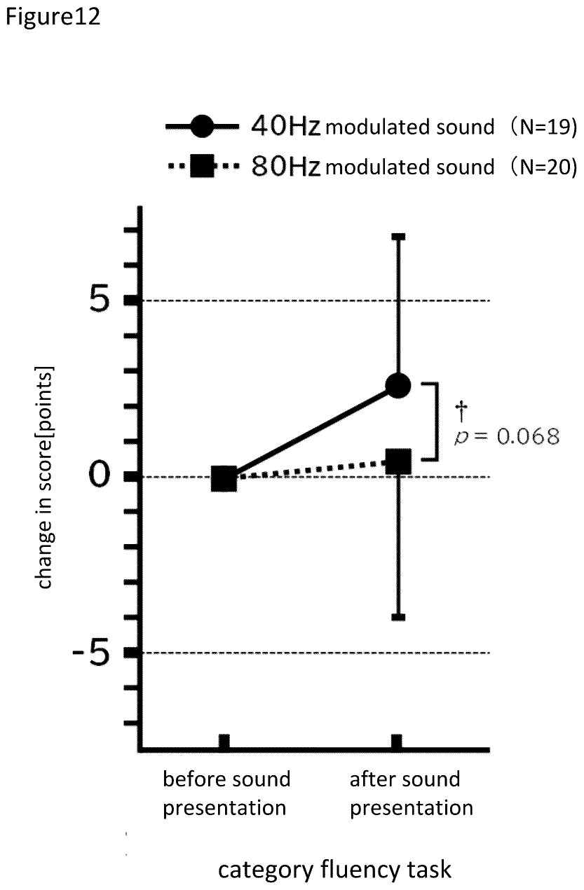

The specific details of the CFT conducted in the experiment of Example 2 were the same as the CFT performed in the experiment of Example 1 described above, and the standardized scores were evaluated based on the number of words counted in measurements before and after the presentation of the sound source. The results are shown in FIG. 12. FIG. 12 is a figure showing the results of the category fluency task in Example 2.

As shown in FIG. 12, there was a tendency for scores to improve only in the intervention group that listened to the modulated sound generated by 40 Hz amplitude modulation. Specifically, the change in score before and after sound presentation was +2.58±4.23 points in the intervention group and +0.40±4.44 points in the SHAM group, with the difference between groups being p=0.068.

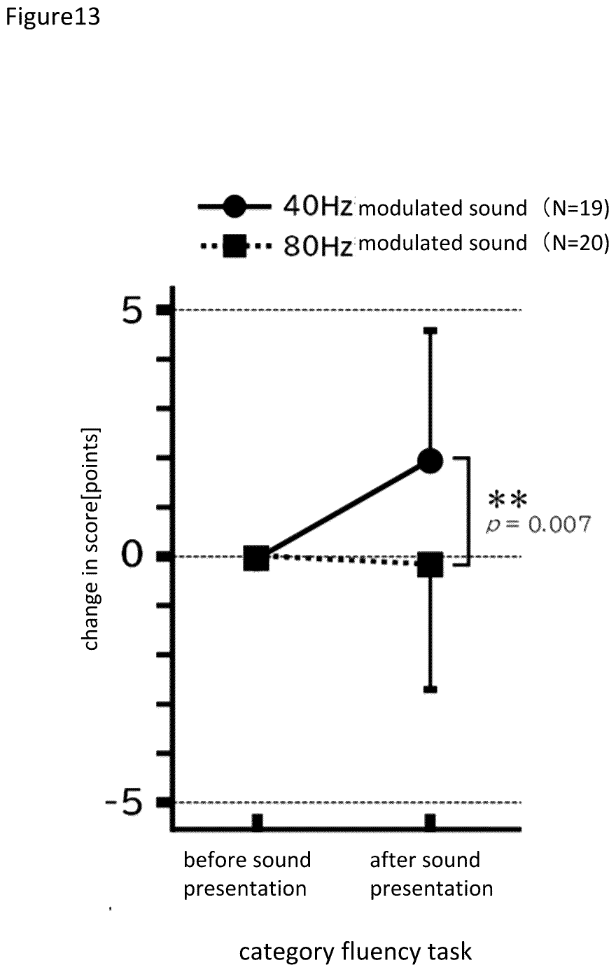

The specific details of the IFT conducted in the experiment of Example 2 are as follows. In the measurement before presenting the sound source, subjects were asked to list as many uses as possible for a “wooden cutting board” within 120 seconds, and the number of uses they were able to list was counted. In the measurement after presenting the sound source, subjects were asked to list as many uses as possible for an “empty can of canned food” within 120 seconds, and the number of listed uses was counted. Then, the number of uses counted before and after the sound source presentation was evaluated. The results are shown in FIG. 13. FIG. 13 shows the results of the idea fluency task in Example 2.

As shown in FIG. 13, only the intervention group, which listened to the modulated sound generated by 40 Hz amplitude modulation, showed an improvement in scores. Specifically, the change in scores before and after the sound source presentation was +2.14±2.71 points in the intervention group, and −0.12±2.65 points in the SHAM group, with a significant difference between the groups (p=0.007).

### (3-3) Example 3

In the experiment corresponding to Example 3, 37 healthy subjects (37.7±8.7 years old) were selected, and three types of sound sources were prepared. The first sound source was unmodulated white noise (WN). The second sound source was a modulated sound (GWS: Gamma Wave Sound) generated by applying 40 Hz amplitude modulation to the white noise. The third sound source was a binaural beat (BB) consisting of a 440 Hz sine wave presented to the right ear and a 400 Hz sine wave presented to the left ear. Each of these three types of sound sources was presented to all subjects through headphones at an equivalent noise level of 74 dB. These three types of sound sources were presented in a counterbalanced order.

For each of the three types of sound sources mentioned above, the Sustained Attention to Response Task (SART) was measured during the presentation of the sound source. The SART allows evaluation of the participant's attention function. In general, attention functions are classified into four types: sustained attention, selective attention, divided attention, and alternating attention. The SART is a type of Continuous Performance Test (CPT) used to evaluate sustained attention, which is the ability to maintain focus on a single task and is particularly influenced by cognitive functions involving the frontal lobe or the network between the frontal and parietal lobes.

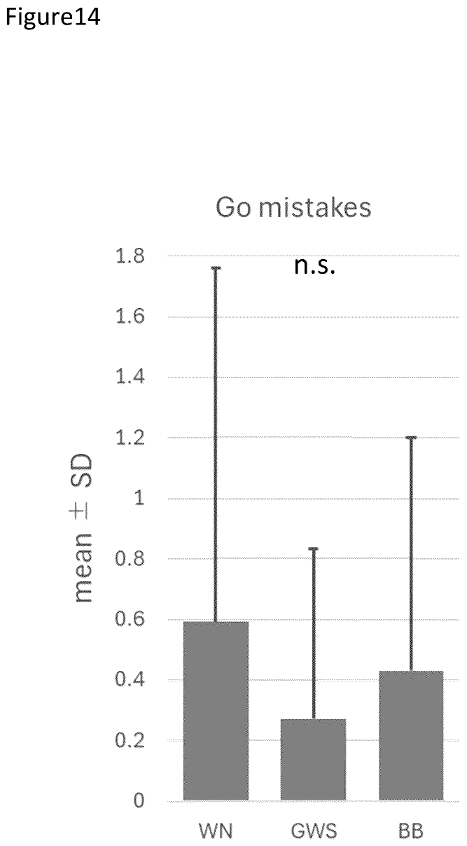

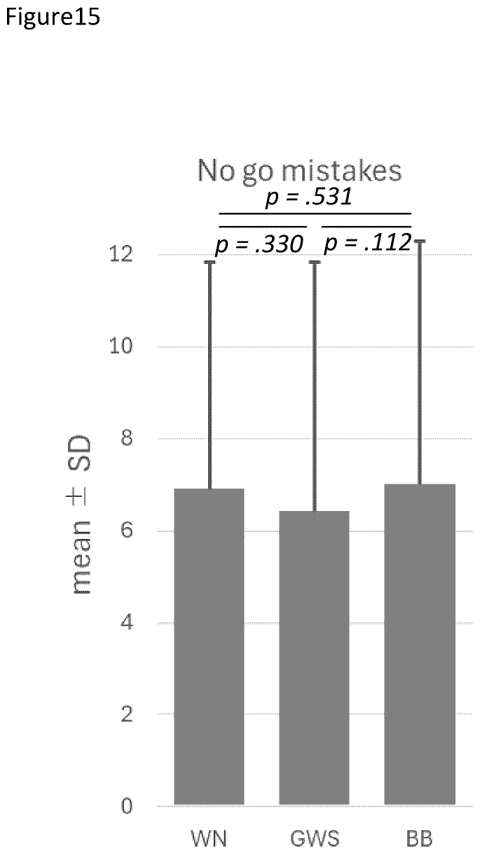

The specific details of the SART conducted in the experiment of Example 3 are as follows. Numbers from 1 to 9 are continuously displayed on a screen placed in front of the subjects in a random order. The subjects are instructed not to press the button when a specific number (the number 3) is displayed, and to press the button as quickly as possible when any other number is displayed. The number of times the subject pressed the button during 25 trials in which a specific number was displayed (judged as No go mistakes) and the number of times the subject did not press the button during 200 trials in which other numbers were displayed (judged as Go mistakes) were each counted, and those counts were evaluated. The results are shown in FIG. 14 and FIG. 15. FIG. 14 is a diagram showing the evaluation results of the number of Go mistakes in the sustained attention task of Example 3. FIG. 15 is a diagram showing the evaluation results of the number of No-go mistakes in the sustained attention task of Example 3.

As shown in FIG. 14, comparing the average number of Go mistakes, the number of mistakes is fewer when presenting binaural beats (BB) than when presenting white noise (WN), and even fewer mistakes are observed when presenting modulated sounds (GWS). Additionally, as shown in FIG. 15, comparing the average number of No go mistakes, fewer mistakes occur when presenting modulated sounds (GWS) than when presenting either white noise (WN) or binaural beats (BB).

### (3-4) Summary of the Example

In Example 1, it was shown that administering auditory stimulus based on a signal having pulses with a period corresponding to 40 Hz to subjects improved the results of the Category Fluency Task (CFT). In Example 2, it was shown that the results of the Category Fluency Task (CFT) and the Idea Fluency Task (IFT) improved by administering subjects with auditory stimulus based on signals generated by performing 40 Hz amplitude modulation on the input acoustic signals. These results indicate that administering subjects with auditory stimulus based on acoustic signals having periodic fluctuations corresponding to 40 Hz improves the subjects'fluency. Furthermore, since CFT and IFT can assess the cognitive and executive functions related to the subject's language, it has been demonstrated that administering auditory stimulus based on acoustic signals with periodic fluctuations corresponding to 40 Hz to the subject can improve the subject's cognitive and executive functions related to language. Also, since the TCT used as the IFT in Example 2 assesses the creative thinking of the subjects, it was shown that administering auditory stimulus based on acoustic signals with periodic fluctuations corresponding to 40 Hz to the subjects improved cognitive functions related to their creativity. In Example 3, it was demonstrated that administering subjects with auditory stimulus based on signals generated by applying 40 Hz amplitude modulation to white noise improves the results of a sustained attention task (SART). This result indicates that administering subjects with auditory stimuli based on acoustic signals having periodic fluctuations corresponding to 40 Hz can improve their attentional function. From the above, by the user US1 listening to the sound emitted from the acoustic output device 30 in the present embodiment, at least any of the following can be expected: improvement of the user's attention function, improvement of fluency, improvement of executive function, improvement of creativity, and improvement of cognitive function.

### (4) Acoustic Signal Processing

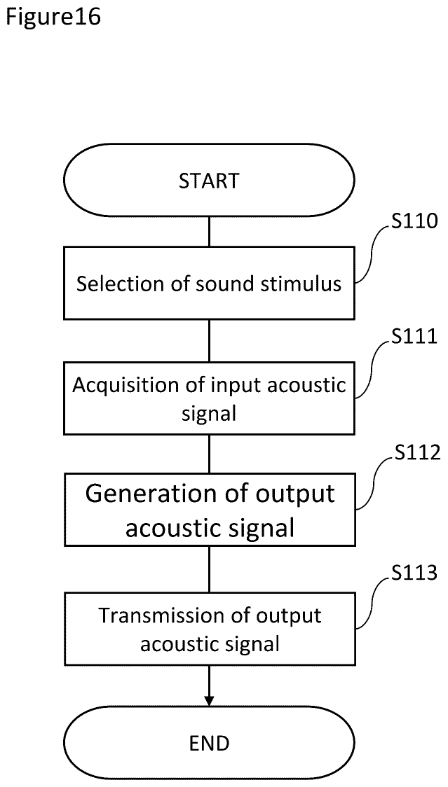

Acoustic signal processing in the present embodiment will be described. FIG. 16 is a diagram showing the overall flow of acoustic signal processing by the signal processing device 10 in the present embodiment. The process in FIG. 16 is realized by the processor 12 of the signal processing device 10 reading and executing a program stored in the storage device 11. It is noted that at least part of the process in FIG. 16 may be realized by one or more dedicated circuits.

The acoustic signal processing in FIG. 16 starts in accordance with the fulfillment of any of the following start conditions.
The acoustic signal processing in FIG. 16 was called by other processing or an instruction from outside.
The user performed an operation to invoke the acoustic signal processing in FIG. 16.
The signal processing device 10 reached a predetermined state (for example, powered on).
A predetermined date and time arrived.
A predetermined amount of time has passed since a predetermined event (for example, the startup of the signal processing device 10 or the previous execution of the acoustic signal processing shown in FIG. 16).

As shown in FIG. 16, the signal processing device 10 executes the selection of the auditory stimulus (S110). Specifically, the signal processing device 10 selects the type of output acoustic signal generated to administer an acoustic stimulus to the subject from among multiple types previously stored. For example, the signal processing device 10 selects which of the five types of output acoustic signals, described with reference to FIG. 5 to FIG. 9, to generate. Which type of output acoustic signal to select may be determined based on input operations by the user or others, or instructions from outside, or it may be determined by an algorithm.

In this embodiment, “others” includes at least one of the following individuals, for example.
The user's family, friends, or acquaintances
Medical personnel (for example, the user's attending physician)
The creator or provider of the content corresponding to the input acoustic signal
The provider of the signal processing device 10
The administrator of the facility used by the user

Furthermore, when the signal processing device 10 selects an amplitude-modulated acoustic signal of the input acoustic signal (for example, the acoustic signals shown in FIG. 5 to FIG. 7) as the output acoustic signal, it determines the modulation method. The modulation method decided here includes at least one of the modulation function used for the modulation process and the modulation index that corresponds to the degree of amplitude variation caused by modulation. The choice of which modulation function to select may be decided based on input operations by the user or others, or instructions from external sources, or it may be determined by an algorithm.

After step S110, the signal processing device 10 performs the acquisition of the input acoustic signal (S111). Specifically, the signal processing device 10 accepts an input acoustic signal sent from the sound source device 50. In step S111, the signal processing device 10 may further perform A/D conversion of the input acoustic signal. Note that in step S110, if an acoustic signal generated without using the input acoustic signal (for example, an acoustic signal shown in FIG. 9) is selected as the output acoustic signal, the signal processing device 10 may omit the processing in S111.

The input acoustic signal corresponds to at least one of the following, for example. Music content (for example, singing, playing, or a combination of these, i.e., musical pieces). It may include audio content accompanying video content.) Audio content (for example, recitation, narration, announcements, radio dramas, solo performances, conversations, monologues, or a combination of these audio types. It may include audio content accompanying video content.)

Other sound content (for example, electronic sounds, environmental sounds, or mechanical sounds).

However, singing or audio content is not limited to sounds produced by the human vocal apparatus, and may include sounds generated by voice synthesis technology.

After step S111, the signal processing device 10 performs the generation of the output acoustic signal (S112). For example, in S110, if an amplitude-modulated acoustic signal derived from the input acoustic signal (such as the acoustic signals shown in FIG. 5 through 7) is selected as the output acoustic signal, the signal processing device 10 performs modulation processing on the input acoustic signal obtained in S111. As an example, the signal processing device 10 performs amplitude modulation on the input acoustic signal using a modulation function with a frequency corresponding to gamma waves (for instance, a frequency between 35 Hz and 45 Hz). As a result, the input acoustic signal is superimposed with amplitude variations (periodic volume fluctuations) corresponding to the above frequencies.

Also, for example, in S110, when an acoustic signal obtained by adding an auxiliary acoustic signal to the input acoustic signal (for example, the acoustic signal shown in FIG. 8) is selected as the output acoustic signal, the signal processing device 10 generates the auxiliary acoustic signal and adds it to the input acoustic signal acquired in S111. As an example, the signal processing device 10 adds an auxiliary acoustic signal that has pulses with a period corresponding to the frequency of gamma waves (for example, a frequency between 35 Hz and 45 Hz) to the input acoustic signal. As a result, the acoustic signal after addition also has periodic variations corresponding to the frequency of gamma waves.

Also, for example, when an independently generated acoustic signal (such as the acoustic signal shown in FIG. 9) is selected as the output acoustic signal at S110, the signal processing device 10 generates the output acoustic signal without using the input acoustic signal. As an example, the signal processing device 10 generates an output acoustic signal that has pulses with a period corresponding to the frequency of gamma waves (for example, a frequency between 35 Hz and 45 Hz).

In step S112, the signal processing device 10 may further perform at least one of amplifying the output acoustic signal, adjusting the volume, or D/A conversion.

After step S112, the signal processing device 10 transmits the output acoustic signal (S113). Specifically, the signal processing device 10 sends the output acoustic signal generated in step S112 to the acoustic output device 30. The acoustic output device 30 generates sound corresponding to the output acoustic signal, thereby administering the auditory stimulus to the listener.

The signal processing device 10 ends the acoustic signal processing shown in FIG. 16 at step S113. The processing shown in FIG. 16 may end according to specific termination conditions (for example, a certain amount of time has passed, user operation has been performed, or the output history of the auditory stimulus has reached a predetermined state). The order of the processing by the signal processing device 10 is not limited to the example shown in FIG. 16; for instance, acquisition of the input acoustic signal (S111) may be performed before the selection of the auditory stimulus (S110).

### (5) Summary

As explained above, the signal processing device 10 of this embodiment generates an output acoustic signal with periodic fluctuations corresponding to the frequency of gamma waves. The signal processing device 10 administers an auditory stimulus based on the generated output acoustic signal to the subject via the acoustic output device 30, thereby improving the brain function of the subject.

The brain functions improved by administering the auditory stimulus include at least one of the following.
Attention function
Fluency
Executive function
Creativity
Cognitive functions related to language
Cognitive functions influenced by activation of at least one of the frontal lobes, hippocampus, and precuneus
Cognitive functions assessable by frontal lobe function tests
Attention functions assessable by continuous attention tasks
Cognitive functions assessable by category fluency tasks
Cognitive functions assessable by idea fluency tasks
Functions for memory search
Function to recall memories

The frequency of the gamma wave corresponding to the periodic fluctuations of the output acoustic signal may be a frequency between 35 Hz and 45 Hz. The frequency of the gamma wave corresponding to the periodic fluctuations of the output acoustic signal may be a frequency

The output acoustic signal may be a signal having pulses at periods corresponding to the frequency of the gamma wave. As a result, greater improvement effects can be expected when auditory stimulus based on the output acoustic signal are presented to the subject.

The output acoustic signal may be generated by performing amplitude modulation according to the frequency of the gamma waves on the input acoustic signal. As a result, the subject can receive auditory stimulus while listening to the content contained in the input acoustic signal (for example, music or speech).

### (6) Modification Example

The storage device 11 may be connected to the signal processing device 10 via a network NW. The display 21 may be built into the signal processing device 10.

The above explanation showed an example in which the signal processing device 10 modulates the entire input acoustic signal. However, the signal processing device 10 may extract a part of the input acoustic signal (for example, background noise that does not include a human voice), perform modulation only on the extracted acoustic signal, and generate an output acoustic signal.

The above explanation illustrated an example in which the signal processing device 10 sends the output acoustic signal generated by modulating the input acoustic signal to the acoustic output device 30. However, the signal processing device 10 may generate an output acoustic signal by synthesizing other acoustic signals with the modulated input acoustic signal obtained by modulating the input acoustic signal, and send the generated output acoustic signal to the acoustic output device 30. Also, the signal processing device 10 may send the modulated input acoustic signal and other acoustic signals to the acoustic output device 30 simultaneously without synthesizing them.

In the above explanation, the output acoustic signal generated by the signal processing device 10 modulating the input acoustic signal is shown as an example where the envelope of the amplitude waveform becomes an inverse sawtooth wave or a sawtooth wave, and the rise and fall of the envelope are asymmetric. However, the output acoustic signal generated by the signal processing device 10 is not limited to these, and may have other amplitude waveforms with asymmetric rise and fall of the amplitude waveform's envelope.

For example, in the rising part of the envelope, the slope of the tangent to the envelope may gradually decrease or it may gradually increase. Also, for example, in the falling part of the envelope, the slope of the tangent to the envelope may gradually decrease or it may gradually increase.

The above description mainly focuses on an example in which the frequency corresponding to the periodic fluctuation of the output acoustic signal is a frequency between 35 Hz and 45 Hz. However, the output acoustic signal generated by the signal processing device 10 is not limited to this, and it only needs to have a periodic variation that influences the induction of gamma waves in the listener's brain. For example, the periodic variation may correspond to a frequency between 25 Hz and 140 Hz. For example, the frequency corresponding to periodic fluctuations may change over time, and it may partially be a frequency below 35 Hz or above 45 Hz.

In the above description, the case where the output acoustic signal generated by the signal processing device 10 is output to the acoustic output device 30, which emits sound according to the output acoustic signal and lets the user hear it, has been explained. However, the destination for the output acoustic signal from the signal processing device 10 is not limited to this. For example, the signal processing device 10 may output an acoustic output signal to an external storage device or information processing device via a communication network or by broadcasting.

The above has described the embodiments of the present invention in detail, but the scope of the present invention is not limited to the above embodiments. Moreover, various improvements and modifications can be made within the scope without departing from the gist of the present invention. Also, the above embodiments and their variations can be combined.

1. A method for improving attention function of a subject, the method comprising:
generating an acoustic signal having periodic fluctuations corresponding to a frequency of gamma waves; and
improving the attention function of the subject by administering an auditory stimulus based on the generated acoustic signal to the subject.

2. The method according to claim 1, wherein
the administering of the auditory stimulus improves attention function that is evaluated by a sustained attention task.

3. The method according to claim 1, wherein
the frequency of the gamma wave is a frequency between 35 Hz and 45 Hz.

4. The method according to claim 1, wherein
the acoustic signal is a signal having pulses with a period corresponding to the frequency of gamma waves.

5. The method according to claim 1, wherein
the acoustic signal is generated by amplitude modulating an input acoustic signal according to the frequency of gamma waves.

6. A method for improving fluency of a subject, the method comprising:
generating an acoustic signal having periodic fluctuations corresponding to the frequency of gamma waves, and
improving fluency of the subject by administering the auditory stimulus based on the generated acoustic signal to the subject.

7. The method of claim 6, wherein
the administering of the auditory stimulus improves fluency that is evaluated by a category fluency task.

8. The method of claim 6, wherein
the administering of the auditory stimulus improves fluency that is evaluated by an idea fluency task.

9. The method of claim 6, wherein
the frequency of gamma waved is a frequency between 35 Hz and 45 Hz.

10. The method according to claim 6, wherein
the acoustic signal is a signal having pulses with a period corresponding to the frequency of gamma waves.

11. The method according to claim 6, wherein
the acoustic signal is generated by amplitude modulating an input acoustic signal according to the frequency of gamma waves.

12. A method for improving cognitive function of a subject, the method comprising:
generating an acoustic signal having periodic fluctuations corresponding to the frequency of gamma waves; and
improving cognitive function of the subject by administering an auditory stimulus based on the generated acoustic signal to the subject.

13. The method of claim 12, wherein
the administering of the auditory stimulus improves cognitive function related to language.

14. The method of claim 12, wherein
the administering of the auditory stimulus improves cognitive functions that is influenced by activation of at least one of frontal lobe, hippocampus and precuneus.

15. The method of claim 12, wherein
the administering of the auditory stimulus improves cognitive function that is evaluated by frontal assessment battery.

16. The method of claim 12, wherein
the administering of the auditory stimulus improves executive function of the subject.

17. The method of claim 12, wherein
the administering of the auditory stimulus improves creativity of the subject.

18. The method of claim 12, wherein
the frequency of gamma waves is a frequency between 35 Hz and 45 Hz.

19. The method of claim 12, wherein
the acoustic signal is a signal having pulses with a period corresponding to the frequency of gamma waves.

20. The method of claim 12, wherein
the acoustic signal is generated by amplitude modulating an input acoustic signal according to the frequency of gamma waves.
